(19) United States
(12) Patent Application Publication
(10) Pub. No.: US 2024/0381232 A1
(43) Pub. Date: Nov. 14, 2024

(54) SIGNALING FOR COORDINATION OF ML MODEL ADAPTATION FOR WIRELESS NETWORKS

(71) Applicant: NOKIA TECHNOLOGIES OY, Espoo (FI)

(72) Inventors: István Zsolt Kovács, Aalborg (DK); Oana-Elena Barbu, Aalborg (DK); Afef Feki, Sceaux (FR); Dimitri Gold, Espoo (FI); Sakira Hassan, Espoo (FI); Ahmad Masri, Jyväskylä (FI)

(21) Appl. No.: 18/314,123

(22) Filed: May 8, 2023

(51) Int. Cl. H04W 48/16; H04L 5/00; H04W 28/18

(52) U.S. Cl. CPC H04W 48/16; H04L 5/0048; H04W 28/18

(57) ABSTRACT

A method includes confirming, by a user device with a network node, a set of machine learning (ML) functionality adaptation parameters for the user device to perform adaptation of a ML functionality associated with at least one ML model that is used by the user device to perform a radio access network (RAN)-related function. The set of ML functionality adaptation parameters indicate at least one adaptation cycle during which the user device is to perform the ML functionality adaptation and a validity period for which the set of ML functionality adaptation parameters are valid. The method also includes performing, by the user device, adaptation of the ML functionality during the at least one adaptation cycle.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency. Other wireless networks are now being developed, such as 6G.

### SUMMARY

A method may include confirming, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and performing, by the user device, adaptation of the ML functionality during the at least one adaptation cycle.

An apparatus may include at least one processor; and at least one memory including computer program code; the at least one memory and the computer program code configured to, with the at least one processor, cause the apparatus at least to: confirm, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and perform, by the user device, adaptation of the ML functionality during the at least one adaptation cycle.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a UE according to an example embodiment.

FIGS. 3A-3C are diagrams illustrating examples of parameters and/or configurations for different example MAP.

FIG. 4 is a diagram illustrating another example of adaptation cycles, and one or more parameters and/or a configuration for a MAP.

FIG. 5 is a diagram illustrating yet another example of adaptation cycles, and one or more parameters and/or a configuration for a MAP.

FIG. 6 is a diagram illustrating operation of a UE 614 and gNB 612 according to an example embodiment in which ML model adaptation is performed at the UE, and the set of model adaptation parameters are provided by the UE to the network node or gNB.

FIG. 7 is a diagram illustrating operation of a UE 614 and gNB 612 according to an example embodiment in which ML model adaptation is performed at the UE, and the set of model adaptation parameters are provided by the network node or gNB to the UE.

FIG. 8 is a block diagram of a wireless station or node (e.g., network node, such as gNB), user node or UE, relay node, or other node).

### DETAILED DESCRIPTION

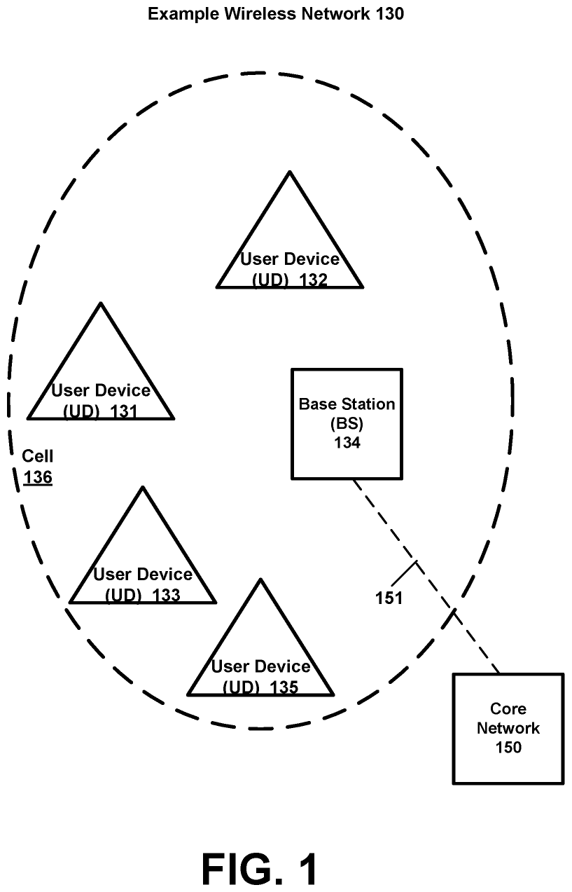

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) and/or 6G, as examples, may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks. 6G and other wireless networks may continue to require even greater performance.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mmWave band networks, IoT, MTC, eMTC, eMBB, URLLC, 6G, etc., or any other wireless network or wireless technology. These example networks, technologies or data service types are provided only as illustrative examples.

According to an example embodiment, a machine learning (ML) model may be used within a wireless network to perform (or assist with performing) one or more tasks. In general, one or more nodes (e.g., BS, gNB, eNB, RAN node, user node, UE, user device, relay node, or other wireless node) within a wireless network may use or employ a ML model, e.g., such as, for example a neural network model (e.g., which may be referred to as a neural network, an artificial intelligence (AI) neural network, an AI neural network model, an AI model, a machine learning (ML) model or algorithm, a model, or other term) to perform, or assist in performing, one or more ML-enabled tasks. Other types of models may also be used. A ML-enabled task may include tasks that may be performed (or assisted in performing) by a ML model, or a task for which a ML model has been trained to perform or assist in performing).

ML-based algorithms or ML models may be used to perform and/or assist with performing a variety of wireless and/or radio resource management (RRM) and/or RAN-related functions or tasks to improve network performance, such as, e.g., in the UE for beam prediction (e.g., predicting a best beam or best beam pair based on measured reference signals), antenna panel or beam control, RRM (radio resource measurement) measurements and feedback (channel state information (CSI) feedback), link monitoring, Transmit Power Control (TPC), etc. In some cases, ML models may be used to improve performance of a wireless network in one or more aspects or as measured by one or more performance indicators or performance criteria.

Models (e.g., neural networks or ML models) may be or may include, for example, computational models used in machine learning made up of nodes organized in layers. The nodes are also referred to as artificial neurons, or simply neurons, and perform a function on provided input to produce some output value. A neural network or ML model may typically require a training period to learn the parameters, i.e., weights, used to map the input to a desired output. The mapping may occur via the function that is learned from a given data for the problem in question. Thus, the weights are weights for the mapping function of the neural network. Each neural network model or ML model may be trained for a particular task.

To provide the output given the input, the ML functionality of a neural network model or ML model should be trained, which may involve learning the proper value for a large number of parameters (e.g., weights and/or biases) for the mapping function (or of the ML functionality of the ML model). For example, the parameters may be used to weight and/or adjust terms in the mapping function. This training may be an iterative process, with the values of the weights and/or biases being tweaked over many (e.g., tens, hundreds and/or thousands) of rounds of training episodes or training iterations until arriving at the optimal, or most accurate, values (or weights and/or biases). In the context of neural networks (neural network models) or ML models, the parameters may be initialized, often with random values, and a training optimizer iteratively updates the parameters (e.g., weights) of the neural network to minimize error in the mapping function. In other words, during each round, or step, of iterative training the network updates the values of the parameters so that the values of the parameters eventually converge to the optimal values.

ML models may be trained in either a supervised or unsupervised manner, as examples. In supervised learning, training examples are provided to the ML model or other machine learning algorithm. A training example includes the inputs and a desired or previously observed output. Training examples are also referred to as labeled data because the input is labeled with the desired or observed output. In the case of a neural network (which may be a specific case of ML model), the network (or ML model) learns the values for the weights used in the mapping function or ML functionality of the ML model that most often result in the desired output when given the training inputs. In unsupervised training, the ML model learns to identify a structure or pattern in the provided input. In other words, the model identifies implicit relationships in the data. Unsupervised learning is used in many machine learning problems and typically requires a large set of unlabeled data.

According to an example embodiment, a ML model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include finding specific relationships or structure in the input data that allow us to effectively produce correct output data. In some example cases, the input signal may be only partially available, or restricted to special feedback. Semi-supervised learning: the computer may be given only an incomplete training signal; a training set with some (often many) of the target outputs missing. Active learning: the computer can only obtain training labels for a limited set of instances (based on a budget), and also may optimize its choice of objects for which to acquire labels. When used interactively, these can be presented to the user for labeling.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

Initially, for example, at least in some cases, the ML models used in UEs may be deployed (pre)trained ‘offline’ at the time of UE production. In addition, at least in some cases, for optimized performance, ML models used by UEs may need to be adapted (e.g., adapting, re-tuning or adjusting weights and/or biases of the ML model) by the UE, e.g., based on radio information and conditions available only during operation in the NG-RAN (IDLE/INACTIVE or CONNECTED mode of the UE). Thus, ML functionality (e.g., ML model biases and/or weights) may be adjusted or adapted. Adapting ML functionality associated with at least one ML model may include, for example, adapting, re-training, re-tuning and/or or adjusting weights and/or biases of the ML model. Thus, the ML functionality associated with a ML model may be or may include (or may be described by) the weights and/or biases of (or associated with) a ML model. Depending on the use case, this adaptation of ML functionality associated with at least one ML model (e.g., adaptation and/or adjusting weights and/or biases of the ML model) by the UE may be best performed by the UE based on coordination between UE and the network (e.g., based on coordination between the UE and the gNB or network node)). For example, in some cases, the UE ML model (re)training (or ML functionality of the ML model re-training or adaptation) may require a new configuration of the reference signals or other updated signals or inputs from the network to the ML model, which may require assistance from the network node for data collection (e.g., labelling) or additional radio resources. Thus, in some cases, proper and/or accurate adaptation of a ML model (or adaptation of ML functionality associated with one or more ML models) may require the network node to be aware of requirements and/or inputs to the UE ML model, which may require collaboration and/or communication between the UE and network node (or gNB or RAN node). This collaboration between network node (or gNB) and UE may also improve the quality of the input data/signals needed by the UE for ML model adaptation or (re)training.

In addition, the computational power restrictions in a UE hardware and software platform (CPU/GPU cores, L1/L2 memory, MAC/cycle, etc.), which are unlikely to be exposed explicitly to the 3GPP network, may typically impose limits to the amount, frequency and/or the extent to which the deployed ML model(s) at a UE can be (re-)trained or adapted on-device (e.g., by the UE), after their deployment and during normal operation of the UE in the radio access network. Furthermore, performing re-training or adaptation of the ML functionality or adaptation of the weights or biases of the ML model may consume significant UE resources (e.g., hardware and/or software) and extend over a significant period of time. Thus, if a ML model will be used by the UE to perform (or assist in performing) a RAN-related function (e.g., such as beam prediction, UE transmit power control, channel state information (CSI) compression, CSI prediction, mobility prediction, access protocol adaptation, or other RAN-related function) or other RAN-related function), it may be difficult, at least in some cases, for the UE to simultaneously use the ML model in inference mode to perform the RAN-related function (e.g., beam prediction) and to perform ML model (or ML functionality) adaptation or re-training, due to UE resource (e.g., hardware and/or software) limitations. Also, in some cases, the period of time required for the UE to perform ML model adaptation (e.g., based on new network conditions or updated reference signals, and the like) may be significant. Thus, in some cases, the UE may need to cease or pause use of the ML model in inference mode to perform the RAN-related function while the UE performs adaptation or re-training of the ML model (adaptation of the ML functionality of at least one ML model). Therefore, at least in some cases, due to a significant period of time that may be required to perform ML model adaptation by the UE, it may be impractical or difficult for the UE to discontinue or pause use of the ML model in inference mode to perform the RAN-related function for such period of time while the UE is performing ML model adaptation, without a significant decrease in UE or network performance.

Therefore, in some cases, a UE performing re-training or adaptation of a ML model or ML functionality associated with one or more ML models may give rise to one or more challenges or problems, such as, for example, one or more of the following technical challenges: 1) collaboration between UE and gNB may be required or at least desirable, e.g., to request adjustment of reference signals or other inputs to the ML model for adaptation, and/or otherwise coordinate the ML model adaptation by the UE, and there presently are no known techniques or agreements specified in 3GPP on how the UE and network node should coordinate for the UE ML model adaptation; 2) inputs or signals used for the ML model adaptation should remain constant during the ML model adaptation; otherwise, if such inputs to the ML model change during ML model adaptation, this may (at least in some cases) render such ML model adaptation as invalid or erroneous, and thus, result in a waste of UE resources to perform such ML model adaptation; and/or 3) in some cases, UE resource (e.g., UE hardware and/or software) constraints may make it difficult for the UE to simultaneously perform both ML model inference and ML model adaptation. Thus, as noted, the UE may need to cease or pause use of the ML model while performing ML model adaptation; and/or, in some cases, the UE performing a ML model adaption while pausing use of the ML model at the UE for the RAN-related function for such a significant period of time to complete ML model adaptation/re-training may negatively impact UE performance and/or network performance.

Therefore, according to an example embodiment, various techniques, solutions and/or features are provided and/or described. According to an example embodiment, a UE (or user device) and a network node (e.g., gNB) may agree or confirm, a set of machine learning (ML) functionality adaptation parameters for the UE to perform adaptation of a ML functionality associated with at least one ML model that is used by the UE to perform a radio access network (RAN)-related function (e.g., beam prediction, UE power control, or other RAN-related function). Adaptation of ML functionality of ML functionality may include, for example, adapting or retraining weights and/or biases of a ML model(s). The set of ML functionality adaptation parameters may indicate (or may include information indicating) at least one adaptation cycle during which the UE (or user device) is to perform the ML functionality (or ML model) adaptation (e.g., ML model re-training), and a validity period for which the set of ML functionality adaptation parameters are valid.

The UE may perform adaptation of the ML functionality (or ML model adaptation or re-training) during the at least one adaptation cycle. This may allow the UE and network node (e.g., gNB) to have a common or agreed upon set of adaptation parameters, such as a validity period and at least one adaptation cycle (or a plurality of adaptation cycles) during which the UE may perform ML functionality (or ML model) adaptation or re-training. Gaps (e.g., presence or absence of gaps, and/or a duration, length or period of such gaps between adaptation cycles) between the adaptation cycles may or may not be present or configured or agreed upon as part of the set of ML functionality adaptation parameters.

For example, a ML functionality adaptation may include (or may be performed within) at least one adaptation cycle, and in some cases, a ML functionality adaptation may include (or may be performed within) a plurality of adaptation cycles. According to an example embodiment, ML functionality (or ML model) adaptation or re-training, or a portion of the adaptation or re-training, may be performed by the UE during each of the adaptation cycles. As noted, in some cases, a gap may be provided between each of the adaptation cycles, e.g., to allow the UE to perform other functions or tasks, such as to allow the UE to use the ML model in inference model to perform the RAN-related function during one or more of the gaps or time periods between each of the adaptation cycles.

Therefore, for example, the UE performing ML functionality adaptation may include the UE performing a portion (or adaptation iteration) of the ML functionality adaptation during each of a plurality of adaptation cycles. Thus, for example, a ML functionality adaptation or re-training may be broken or divided up into smaller chunks of ML functionality adaptation re-training that are performed in each of the adaptation cycles, thereby freeing up (or making available) the UE resources and thereby allow the ML functionality (associated with one or more ML models) to perform the RAN-related function in a gap or time period between each of the adaptation cycles, until the ML functionality adaptation is completed. While this may extend or lengthen a period of time required for ML functionality adaptation or re-training, this may allow the ML functionality adaptation to be performed by the UE with less negative impact to UE or network performance (and/or improve UE or network performance), since operation of the ML model in inference mode is paused or ceased only for shorter periods of time, rather than pausing or ceasing use of the ML model in inference mode during the entire ML functionality (or ML model) adaptation or re-training. For example, allowing UE to use the ML model in inference mode during gaps or periods between adaptation cycles may allow the UE to more frequently perform or update beam prediction, thereby improving UE or network performance and/or mitigating the decrease in UE or network performance that otherwise might occur if the ML model was not used (or use of ML model in inference mode for UE beam prediction was paused or offline) during the entire ML functionality (or ML model) adaptation without such gaps. Thus, the same ML model (or same ML functionality associated with at least one ML model) may be adapted during adaptation cycles, and then may be used in inference model in gaps between adaptation cycles. Also, for example, the adapted ML functionality associated with at least one ML model may not be fully or completely adapted or re-trained until the end of the model adaptation, e.g., performed across a plurality of adaptation cycles. After adaptation of the ML functionality is completed, this adapted or re-trained ML functionality associated with at least one ML model may be used in inference mode to perform the RAN-related function.

Also, for example, two different ML models, to be used for the same RAN-related function, may be adapted and used in inference mode. Thus, ML functionality associated with a first ML model (to be used to perform a first RAN-related function) may be adapted during adaptation cycles, while a second ML model (or even a non-ML algorithm) may be used in inference mode to perform the same RAN-related function. Thus, said another way, it is not necessarily the same ML model which is adapted during adaptation cycles and also used for inference between adaptation cycles. These could be two different ML models supporting/associated with the same ML functionality (e.g., supporting or used to perform the same RAN-related function). The UE might even use a non-ML algorithm between the adaptation cycles to perform or assist the UE in performing the RAN-related function.

Thus, for example, the UE may use the ML model in inference mode to perform or assist in performing the RAN-related function between the adaptation cycles. Thus, for example, this may allow a UE to divide up a ML functionality (or ML model) adaptation into a plurality of adaptation cycles, and the UE may perform a portion of (or partially perform) the ML functionality (or ML model) adaptation or re-training (e.g., use the ML model in training mode to re-train or adapt the ML model) during each of the adaptation cycles (and e.g., pausing or ceasing use of the ML model to perform the RAN-related function during such UE performing a portion of the ML functionality adaptation), while allowing the UE to resume or perform use of the ML model (e.g., in inference mode) to perform the RAN-related function in the periods between each adaptation cycle, thereby avoiding a long period of time where the ML model is not used by the UE, while ML functionality or ML model adaption or re-training is performed by the UE.

Also, for example, one or more inputs to the ML functionality or ML model, configured by the network node, may remain constant (unchanged) within or during the ML functionality adaptation (or across the plurality of adaptation cycles of the ML functionality adaptation). This may allow a UE to perform more accurate ML functionality adaptation, since the inputs to the ML model will (as agreed upon by UE and gNB) remain the same or remain constant during the ML functionality adaptation. If, for example, there are multiple ML functionality adaptations (e.g., each ML functionality adaptation including at least one adaptation cycle, or a plurality of adaptation cycles), the inputs to the ML functionality associated with at least one ML model may remain constant during or within each ML functionality adaptation, but the inputs to the ML functionality associated with the at least one ML model may be changed between each ML functionality adaptation.

Note, that in an example embodiment, one adaptation of ML functionality associated with at least one ML model, is performed within one validity period, where the validity period includes one or more adaptation cycles. Therefore, for example, the inputs to the ML functionality associated with the ML model should remain constant during or within the adaptation of the ML functionality, which is performed within a validity period. Thus, for example, the inputs to the ML functionality should remain constant or unchanged within a validity period.

In an example embodiment, the set of ML functionality adaptation parameters may include information indicating: the validity period for which the ML functionality adaptation parameters are valid; a number of adaptation cycles within the validity period; and/or an adaptation cycle duration for each adaptation cycle of the at least one adaptation cycle. Also, for example, the at least one adaptation cycle may include a plurality of adaptation cycles, and the adaptation cycle duration for the plurality of adaptation cycles may include at least one of: an adaptation cycle duration for the plurality of adaptation cycles within the validity period, wherein the adaptation cycle duration is the same for each of the adaptation cycles; or an average adaptation cycle duration for the adaptation cycles within the validity period.

Also, according to an example embodiment, the at least one adaptation cycle includes a plurality of adaptation cycles, wherein the set of ML functionality adaptation parameters may include at least one of the following: a number of ML functionality adaptations; a number of the adaptation cycles per ML functionality adaptation; a duration, or an average duration, of the adaptation cycles; a time period between each of the adaptation cycles; or an average time period between each of the adaptation cycles.

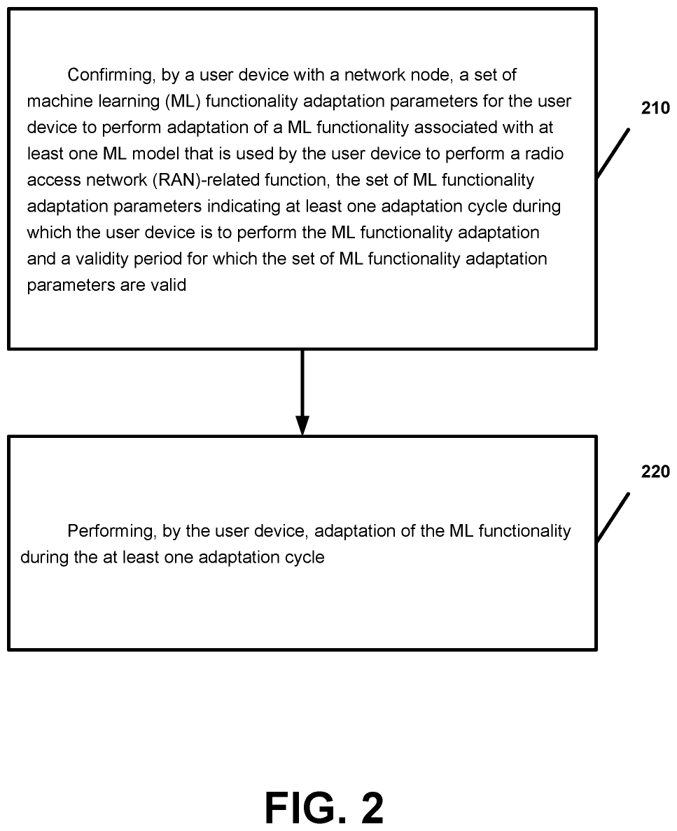

FIG. 2 is a flow chart illustrating operation of a user device (or UE) according to an example embodiment. Operation 210 includes confirming, by a user device (e.g., UE) with a network node (e.g., gNB), a set of machine learning (ML) functionality adaptation parameters for the user device to perform adaptation of a ML functionality of at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid. And, operation 220 includes performing, by the user device, adaptation of the ML functionality during the at least one adaptation cycle.

With respect to the method of FIG. 2, the at least one adaptation cycle includes a plurality of adaptation cycles, wherein the performing adaptation comprises performing, by the user device, adaptation of the ML functionality during the plurality of adaptation cycles; the method further comprising: using, by the user device, the at least one ML model in inference mode to perform or assist in performing the RAN-related function between the adaptation cycles.

With respect to the method of FIG. 2, the confirming may include: transmitting, by the user device to the network node, the set of ML functionality adaptation parameters for performing adaptation of the ML functionality; and receiving, by the user device from the network node, an acknowledgement confirming that the set of ML functionality adaptation parameters are acceptable.

With respect to the method of FIG. 2, the confirming may include: receiving, by the user device from the network node, the set of ML functionality adaptation parameters for performing adaptation of the ML functionality; and transmitting, by the user device to the network node, an acknowledgement confirming that the set of ML functionality adaptation parameters are acceptable.

With respect to the method of FIG. 2, the set of ML functionality adaptation parameters may include information indicating: the validity period for which the ML functionality adaptation parameters are valid; a number of adaptation cycles within the validity period; and an adaptation cycle duration for each adaptation cycle of the at least one adaptation cycle.

With respect to the method of FIG. 2, the at least one adaptation cycle may include a plurality of adaptation cycles, wherein the adaptation cycle duration for the plurality of adaptation cycles includes at least one of: an adaptation cycle duration for the plurality of adaptation cycles within the validity period, wherein the adaptation cycle duration is the same for each of the adaptation cycles; or an average adaptation cycle duration for the adaptation cycles within the validity period.

With respect to the method of FIG. 2, wherein the at least one adaptation cycle may include a plurality of adaptation cycles, wherein the set of ML functionality adaptation parameters includes at least one of the following: a number of ML functionality adaptations; a number of the adaptation cycles per ML functionality adaptation; a duration, or an average duration, of the adaptation cycles; a time period between each of the adaptation cycles; or an average time period between each of the adaptation cycles.

With respect to the method of FIG. 2, one or more inputs to the ML functionality, which are configured by the network node, remain constant during the validity period.

With respect to the method of FIG. 2, performing adaptation of the ML functionality may include: performing a plurality of ML functionality adaptations, wherein each ML functionality adaptation comprises a plurality of adaptation cycles; wherein one or more inputs to the ML functionality, which are configured by the network node, remain constant within each of the ML functionality adaptations; and wherein the one or more inputs to the ML functionality, which are configured by the network node, are changed between two of the ML functionality adaptations during the validity period.

With respect to the method of FIG. 2, the method may further include: transmitting, by the user device to the network node, a capabilities response indicating that the user device has a capability to perform at least one of the following: ML functionality adaptation; receive (or receiving), by the user device, the set of ML functionality adaptation parameters; or send or provide (or sending or providing), by the user device to the network node, the set of ML functionality adaptation parameters or a proposed or requested set of ML functionality adaptation parameters.

With respect to the method of FIG. 2, the performing, by the user device, adaptation of the ML functionality during at least one of the plurality of adaptation cycles may be performed based on at least one of the following: receiving, by the user device from the network node, a request to perform adaptation of the ML functionality; or detecting, by the user device, a need to perform adaptation of the ML functionality based on performance of the RAN-related function being less than a threshold.

With respect to the method of FIG. 2, the method may further include transmitting, by the user device to the network node, a request for resources to be used by the user device during the plurality of adaptation cycles within the validity period to perform adaptation of the ML functionality.

With respect to the method of FIG. 2, the adaptation of the ML functionality may be performed partially (e.g., a portion of the adaptation of the ML functionality or ML model is performed each adaptation cycle), and/or in an iterative manner, during each adaptation cycle of the plurality of adaptation cycles.

With respect to the method of FIG. 2, the performing, by the user device, adaptation of the ML functionality may include performing at least one of the following: adapting one or more weights or biases of the at least one ML model; adapting the at least one ML model; adapting a plurality of ML models (or at least one ML mode) that may be associated with the ML functionality (e.g., where the weights and/or biases of the ML functionality may be used on or for the ML models); or adapting an architecture and/or model structure of at least one ML model.

According to an example embodiment, a UE may not necessarily retrain a full model, but may only adjust only some layers (e.g., only some of the weights and/or biases), or part of model, and may not need a very large set of new input data, but only some new data, for example. The model state may be preserved between update cycles, and not discarded, and we adjust/update the model based on some portion of updated data. Model architecture does not change. Weights and biases are adjusted. Thus, for example, some layers, weights and/or biases may be adjusted or updated during each adaptation cycle of at least one adaptation cycle (or of a plurality of adaptation cycles).

ML functionality adaption, or ML model adaptation: A process in which (e.g., part of) the ML functionality associated with one or more ML models may be adapted (e.g., adjusted, re-trained), either locally or at another node side, in response to a trigger, e.g., which may be performed based on or in response to: periodic adaptation, adaptation in response to trigger, performance degradation, in response to a request to perform ML model adaptation, or other trigger. Adaptation of ML functionality associated with one or more ML models (or ML model adaptation) may include any of the following (or combination of): changes due to model re-training (model parameter training with new data and/or model structure changes), changes in the model pruning, changes in the model quantization, and/or changes in the model structure or architecture. Adaptation of ML functionality associated with one or more ML models (or ML model adaptation) may include adaptation of (one or more weights and/or biases of the ML model and/or other changes.

Adaptation cycle for a ML model (which may also be referred to as a ML model adaptation cycle): An adaptation cycle may be a finite time iteration step (or a period) during the model adaptation process, which yields either the targeted ML model update (or ML functionality update) or an intermediary update state as part of a sequence of adaptation cycles, which ends (or is completed) with an updated ML model. The estimation of the time length of one adaptation cycle may use or may assume that some information is used about how fast the required input data is made available by the network (e.g., such as SSB/synchronization signal block reference signal periodicity or CSI-RS/channel state information-reference signal configuration). One model adaptation may include one or more adaptation cycles, and each adaptation cycle may be based on some new input data, for example. The complete ML model adaptation is accomplished after all the ML model adaptations performed in the sequence of one or more adaptation cycles.

(ML) Model adaptation parameters, or ML functionality adaptation parameters (ML MAP, or MAP): MAP (or ML MAP) may be or include the set of ML functionality (or ML model) adaptation parameters defining or indicating various parameters or details of the ML functionality (or ML model) adaptation, e.g., such as information indicating one or more of: at least one adaptation cycle during which the UE may or will perform ML functionality (or ML model) adaptation, a validity period for which the MAP (set of ML model adaptation parameters) is valid, and possibly other parameters. For example, MAP (which may be referred to as ML Map) may indicate or define parameters, such as when and how long UE may/will update/adjust its ML model. ML Map may indicate various update schedule parameters, so the UE and gNB can coordinate the ML model updates and what resources or signal/input updates may be needed by the UE to perform adaptation of the ML model, and/or to allow the UE and gNB to coordinate times or periods (e.g., gaps between adaptation cycles) where the UE may resume or perform using the ML model in inference mode to perform the RAN-related function, for example.

Prior to ML model adaptation, the UE may use, or may be configured to use, one or more ML models (or ML functionality associated with one or more ML models) to perform a RAN-related function or a radio access network (RAN) function. After the UE has performed adaptation of ML functionality associated with one or more ML models, the UE may continue using the adjusted, adapted or re-trained ML functionality for an ML model(s) in inference mode to perform or assist in performing the RAN-related function or RAN function. Prior to the ML model adaptation, the RAN-related function may already be configured and activated, and the underlying ML model (or ML functionality associated with one or more ML models) may have been fully trained and deployed, and now may undergo (further) adaptation or re-training at the UE in accordance with the ML MAP (the set of ML functionality or ML model adaptation parameters). For example, a collaboration between UE to agree or confirm the ML MAP may enable or allow a coordinated ML model adaptation or re-training at the UE, e.g., without the need for the UE to explicitly expose or indicate to the gNB its vendor specific ML compute capabilities/capacity to the serving 3GPP network, for example.

Several additional terms or acronyms are used in the text herein and/or the in Figures:
MAP or ML MAP: a set of ML model (or set of ML functionality) adaptation parameters. The ML MAP may include one or more parameters, such as, for example, one or more of the following parameters, or other parameters indicated herein:
Validity period. A period, indicated in the figures from time Tstart to Tend, which may include one or more model adaptations (e.g., one or more ML model adaptation cycles), where each model adaptation may include one or more adaptation cycles. The validity period is a period during which the ML MAP (or set of adaptation parameters) will remain valid. Also, the inputs used by the ML functionality will remain constant or unchanged during the validity period.
information indicating one or more adaptation cycles. This information may be indicated in different ways, and/or using different parameter(s). For example, if adaptation cycles are periodic or of same duration, then a number of adaptation cycles (Nac) may be used to indicate the one or more adaptation cycles within the validity period. Other parameters and/or techniques may be used as well to indicate the one or more adaptation cycles. For example, alternatively, Nac and Tma or Tma_avg may be provided in ML Map to indicate the adaptation cycles.
ML model adaptation period. A period (e.g., which may be the validity period) for ML functionality (associated with one or more ML models) adaptation that may include one or more adaptation cycles. Also, the gNB may also typically keep the one or more ML model (or ML functionality) inputs or signals constant or non-changing during the ML model adaptation period (e.g., during the validity period), to allow the ML functionality adaptation to be performed by the UE using a consistent or non-changing set of inputs, such as a reference signal configuration. UE may perform ML functionality (or ML model) adaptation within or during each adaptation cycle. A gap or period may be provided between each adaptation cycle, and during each of these gaps, the UE may, for example, cease or discontinue ML functionality (or ML model) adaptation and resume using the ML model (or any other algorithm or model, ML or non-ML) in inference mode to perform or assist in performing the RAN-related function such as a RAN function. Thus, the ML model adaptation period may include an interleaved structure that may include alternating or interleaved adaptation cycles (for ML model or ML functionality adaptation) and gaps (during which a ML model or an algorithm may be used in inference mode to perform a RAN-related function such as a RAN-related function). Thus, during each adaptation cycle, the UE may, for example, pause or cease using the ML model in inference mode to allow the UE to use its resources to perform ML model adaptation or training/re-training, and during each gap between adaptation cycles the ML model adaptation or training is paused or ceased and the UE may use or resume using a ML model (or other ML model or algorithm) to perform the RAN-related function or RAN-related function. Alternatively, during the adaptation cycles, the UE may continue to use the ML model in inference mode to perform the RAN-related function or RAN-related function, while in parallel, adjusting or performing adaptation of the ML model such as adjusting the weights and/or biases of the ML model (or adjusting or performing adaptation of the ML functionality).
A number of ML model adaptations within the validity period. This may indicate the number of ML model adaptations within the validity period.
Nac—the number of adaptation cycles within the ML model adaptation period.
Tma—the duration or period (or length) of the adaptation cycles (may be periodic or same period, or may be aperiodic). Thus, duration of the adaptation cycles may be periodic (same period or duration for the plurality of the adaptation cycles, and the gap between adaptation cycles may be the same duration or length) or aperiodic (a period or duration may be different for the plurality of the adaptation cycles, and the gaps between adaptation cycles are not necessarily the same, but may be a same duration or length, or gaps may be a different duration or length gap, for example).
Tma_avg—the average duration of the adaptation cycles, e.g., if aperiodic.
Other parameters may be included in ML MAP.

Instead of providing to gNB its sensitive vendor (chipset) specific, ML compute (or UE resource) capabilities/capacity, the UE may indicate to the serving NG-RAN node a set of ML adaptation parameters (MAP or ML MAP) for each RAN-related function, including, for example: i) Nac—a number or expected adaptation cycles; ii) the estimated average (Tma_avg) or exact duration (Tma)—the duration or period of model adaptation cycles (but does not necessarily need to be periodic) of each adaptation cycle; and iii) the validity period—e.g., for which the ML MAP is valid, e.g., which may be indicated as Tend-Tstart, and may be indicated via time offset and duration, or Tstart and Tend, or other information. The ML MAP is (or should remain) consistent or the same (or unchanging) during the validity period, since during this time window, the UE may need to perform multiple ML model adaptations, and each ML model adaptation may include multiple adaptation cycles, and the UE may need to use the same inputs/signals or signal configurations during this validity period, and maintaining the same MAP for this validity period may allow the ML model adaptations (e.g., among multiple ML models) to be consistent.

According to an illustrative example embodiment, the average (Tma_avg), or exact (Tma), duration of each adaptation cycle may for example, indicate the total estimated time to: collect the required data (measurements), pre-process the input data (if required), perform ML model re-training/adaptation, and post-process the ML output (if required). Therefore, this parameter does not only cover the ML training/inference latency, but rather the time it takes for the entire RAN-related function to be adapted.

We note that in case a UE (chipset) vendor ML specific server exists (to store ML model IDs, data sets, ML firmware, etc.) and has interfaces to the 3GPP network node or core network, this information can also be used, in combination with the techniques described herein (e.g., exchanged set of ML model adaptation parameters or MAP), to further refine/adapt the triggered signaling from the NG-RAN towards UEs.

For simplicity, by way of illustrative example, we describe the cases when the UE is performing an RAN-related function, and the underlying ML model needs to be adapted to achieve a target performance level. For this, the UE is assumed to need collaboration with the serving gNB, e.g., for configuration and scheduling of radio resources used by the UE to measure the KPIs (key performance indicators) as input data for its ML model. The techniques described herein may also be used for some use cases where the roles of the UE and gNB are swapped. The principles described below can be extended to the case when the RAN-related function uses a two-sided ML model, e.g., in both UE and gNB. Furthermore, the proposed techniques can also be used for UE-to-UE communication scenarios (side-link, ProSe, V2V, UE-to-UE communications, also known as device-to-device communications) where the involved UEs need to establish a certain level of collaboration.

Finally, the feedback from the UE can include the schedule of ML functionality adaptations, history of model adaptations, or instantaneous state of model adaptation. This information can be used either to avoid the change in network configuration during the adaptation phase, or to optimize MAP, and/or to instruct UE to use a default AI/ML or fallback model if changes are needed at the adaptation phase. With this kind of signaling UE can also indicate a need of immediate ML model adaptation out of the predefined schedule defined by MAP.

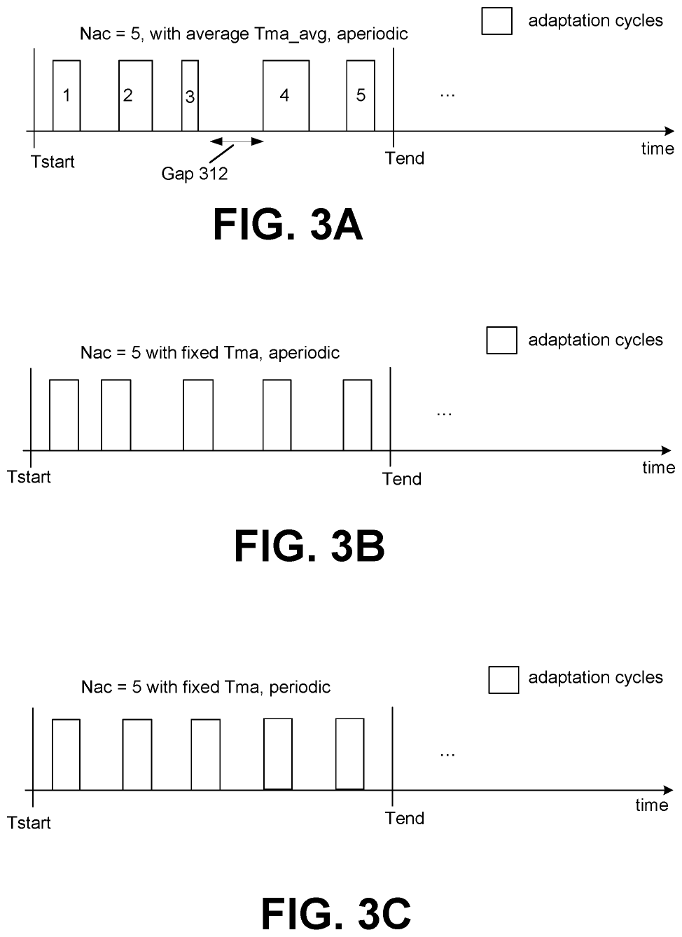

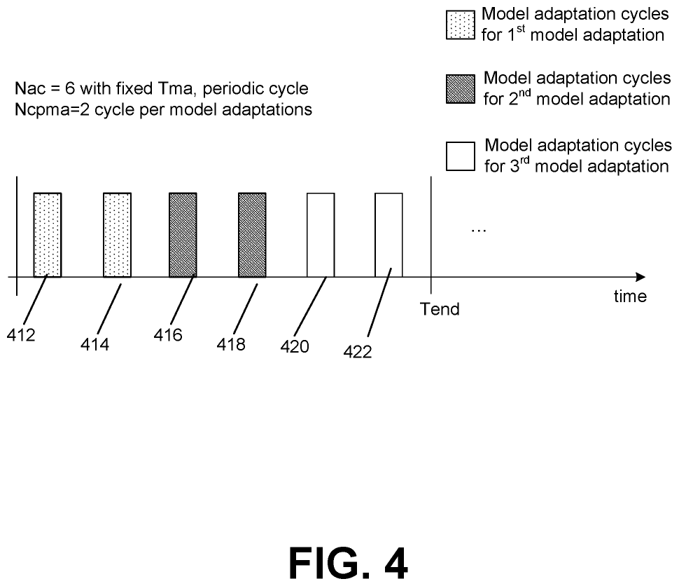

In FIGS. 3A-3C and FIG. 4, examples are shown for adaptation cycles (also referred to as model adaptation cycles and some example ML MAP configuration parameters to be signaled (e.g., from the UE to the gNB) and/or agreed between UE and gNB, when the ML adaptation is performed in the UE. For example, these parameters may be estimated by the ML control firmware specific to the hardware and/or software implementation in collaboration with the 3GPP UE functionalities. The depicted timelines in FIGS. 3A-3C and FIG. 4 are only for visualization purposes and show possible outcomes of the sequence of adaptation cycles. During the time of the ‘white’ intervals or gaps between the adaptation cycles in the UE, the same, a different, or none, ML model is assumed to be used (or may be used by the UE) in inference operating mode, to perform the RAN-related functionality (e.g., such as RAN-related function) by UE. The reason to spread out in time the adaptation cycles is, for example, to be able to adapt a new, or the old model, to the changing radio conditions in time, and/or to utilize the compute resources during ‘inference idle’ times to adapt the ML model.

FIGS. 3A-3C are diagrams illustrating examples of parameters and configurations for different example ML MAP configurations. In FIGS. 3A-3C, for example, the UE internal ML implementation can trigger the start of each adaptation (e.g., based on detected radio conditions changes, detected beams changes, etc). In these cases, the number of expected adaptations (Nac) and their average time duration (Tma_avg), or the exact duration (Tma) for one adaptation cycle, may be estimated by the UE for the time interval Tstart to Tend (which may be the validity period).

In FIGS. 3A-3C, the validity period is indicated as the period from Tstart to Tend. Nac (number of adaptation cycles within the validity period) is equal to 5, meaning that there are 5 adaptation cycles within the validity period.

In FIG. 3A, the aperiodic (having different period or length or time between start of each adaptation cycle) adaptation cycles 1, 2, 3, 4 and 5 are shown, e.g., and also in which some of the 5 adaptation cycles have a different duration (and thus, some of the adaptation cycles may have different gaps or time periods between adaptation cycles) are shown. For example, duration of adaptation cycle 4 is greater than duration of adaptation cycles 1, 2, 3 and 5. Adaptation cycle 3 has the shortest duration of the 5 adaptation cycles in FIG. 3A. The 5 adaptation cycles, although different in duration, may have an average duration of Tma_avg. Note, that a gap is provided between each pair of adjacent adaptation cycles. For example, a gap 312 is provided between adaptation cycles 3 and 4 of FIG. 3A. Likewise, gaps (or time periods) are provided between adaptation cycles 1 and 2, between adaptation cycles 2 and 3, and between adaptation cycles 4 and 5. Thus, ML adaptation (or a portion of ML model adaptation or re-training) may be performed during each of the adaptation cycles 1-5 (e.g., ML model operating in training mode within these adaptation cycles). During the gaps, such as gap 312, ML model adaptation may be ceased or paused, to allow the UE to apply its resources and use the ML model for performing a RAN-related function for which the ML model was previously trained (e.g., using the ML model in inference mode during these gaps between adaptation cycles). Thus, an interleaved structure or arrangement of adaptation cycles alternating with gaps may be provided, where a portion of (or partial) ML model adaptation may be performed by the UE during each or one or more of the adaptation cycles (e.g., while the ML model is used in training mode to train the ML model), and then the ML model may be used in inference mode during each gap (e.g., such as gap 312) to perform a RAN-related function or RAN-related function, such as beam prediction (as an example). In this illustrative example, the ML model adaptation or re-retraining may be completed after adaptation cycle 5 is completed, for example.

In FIG. 3B, Nac (number of adaptation cycles within the validity period) is also 5, and the adaptation cycles are aperiodic, but have the same duration (same Tma). In FIG. 3C, there are also five adaptation cycles (Nac=5), which are periodic (period between start of each successive adaptation cycle is the same), and the five adaptation cycles have a same duration (Tma is same for all 5 adaptation cycles shown in FIG. 3C). Gaps are similarly provided between adaptation cycles shown in FIGS. 3B and 3C, and FIG. 4, for example.

Thus, for example, FIG. 3A illustrates i) aperiodic adaptation cycles with average cycle duration; FIG. 3B illustrates ii) aperiodic adaptation cycles with fixed adaptation cycle duration, and FIG. 3C illustrates iii) periodic adaptation cycles with fixed adaptation cycle duration. For example, each adaptation cycle may be assumed to perform one model adaptation (Nma=1). During the time intervals (or gaps) between the adaptation cycles, the ML model is used in inference operating mode, as part of the normal operation of the RAN-related function (e.g., to perform beam prediction or other RAN-related function).

In FIGS. 3A-3C and FIG. 4, examples show how the UE ML implementation may utilize the available model adaptation cycles. While in FIGS. 3A-3C, each adaptation cycle yields the targeted update of the model. In FIG. 4, each model adaptation takes two cycles. Therefore, an additional parameter which can be included in the MAP is the number of cycles per model adaptation (Ncpma) or, alternatively, number of model adaptations (Nma), not shown. In this scenario, with multiple cycles required for the model update, during the time of the ‘white’ intervals between the adaptation Ncpma cycles, another ML model (or version of the model) might be used to provide the required inference results for the same RAN-related function.

FIG. 4 is a diagram illustrating another example of adaptation cycles, and one or more parameters and/or a configuration for a ML MAP. In the example shown in FIG. 4, there are 3 ML model adaptations, and 6 (total) adaptation cycles (Nac=6). Also, Ncpma (number of adaptation cycles per model adaptation)=2, meaning that each of three ML model adaptations are performed using two adaptation cycles. Adaptation cycles 412 and 414 are provided for a first ML model adaptation; adaptation cycles 416 and 418 are provided for a second ML model adaptation; and adaptation cycles 420 and 422 are provided for a third ML model adaptation. These ML model adaptations may be, for example, to perform adaptation for three different ML models, as an example, or may perform multiple ML adaptations of the same ML model.

For example, one complete ML model adaptation or re-training might need several of these adaptation cycles until the model inference and/or KPIs (key performance indicators, or performance of the ML-enabled function using the ML model) are sufficiently accurate. The UE may indicate to the gNB when the model adaptation or re-training has been completed and can/will be used in the UE.

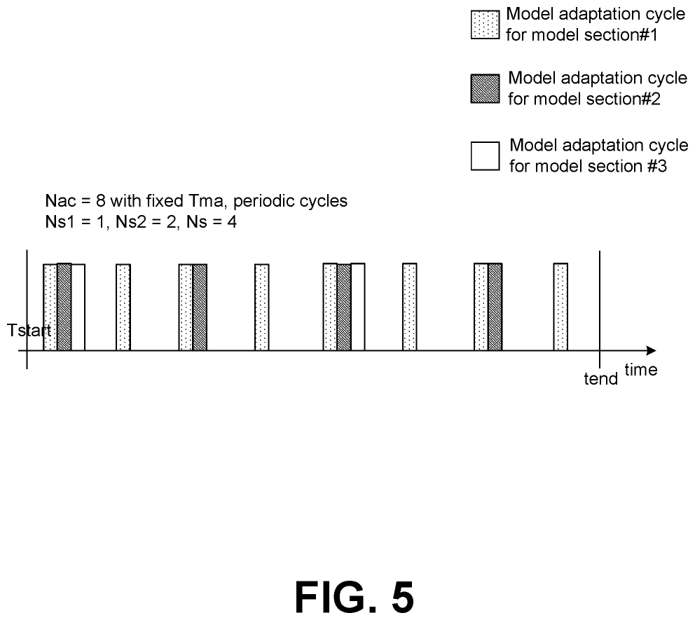

FIG. 5 is a diagram illustrating yet another example of adaptation cycles, and one or more parameters and/or a configuration for a ML MAP. FIG. 5 illustrates another example of ML model adaptation cycle configurations where the ML model is split into model sections (1-3) and each section is adapted separately. Each section of the ML model may have a different update rate (section #1 every cycle, section #2 every 2nd cycle, and section #3 every 4th cycle).

According to an example embodiment, the UE and gNB may confirm and/or agree on a ML functionality adaptation parameters, e.g., which may include, and one or more adaptation cycles during which ML model adaptation may be performed, and a validity period during which the set of ML functionality (or ML model) adaptation parameters are valid. The validity period may be shown in some of the figures as the period from Tstart to Tend. Also, for example, as part of the confirmed (negotiated or agreed upon) set of ML functionality adaptation (or ML model adaptation) parameters, the gNB and/or UE may agree that: 1) gNB will not change network configuration for any of the input parameters to the ML model (e.g., reference signal configurations) during the adaptation period and/or during the validity period; 2) gNB will not typically ask or request the UE to perform a function using the ML model using this ML model during this validity period (or at least during the adaptation cycles within this validity period), e.g., ML model is undergoing training, and ML model is not valid, but UE in some cases might have ability to do both training and inference in parallel. gNB does not schedule or request UE to perform anything for UE to perform using this ML mode. gNB can schedule UE with UL/DL (uplink and/or downlink) traffic, but radio configuration used by this ML functionality (as input data for the ML model(s) adapting), such as reference signal configurations, will not be changed by gNB within this validity period, and/or will not change during the ML functionality adaptation (model adaptation period) that may include one or more adaptation cycles.

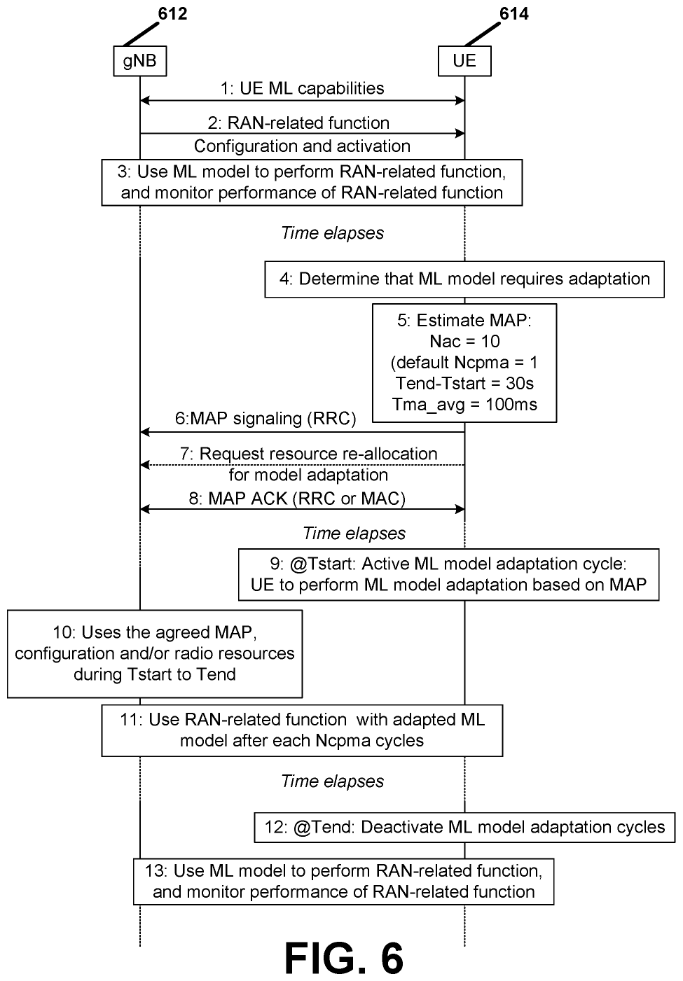

FIG. 6 is a diagram illustrating operation of a UE 614 and gNB 612 according to an example embodiment in which ML model adaptation is performed at the UE, and the set of model adaptation parameters are provided by the UE to the network node or gNB. The operation shown in FIG. 6 may correspond to or be associated with FIGS. 3A-3C, for example. At step 1 of FIG. 6, UE/gNB perform an exchange of capabilities, and the UE 614 indicates its ML model capabilities, e.g, both inference and training/adaptation. For example, the UE 614 may indicate its capability to perform one or more of the following: ML functionality adaptation; receive, by the UE 614, the set of ML functionality adaptation parameters; or send or provide, by the UE to the gNB/network node, the set of ML functionality adaptation parameters or a proposed or requested set of ML functionality adaptation parameters.

At step 2 of FIG. 6, the gNB 612 may acknowledge receipt of these capabilities indication, and enables the UE 614 to perform ML model adaptation and/or enables the UE to send or receive a set of ML model adaptation parameters.

At step 3 of FIG. 6, the UE 614 and/or gNB 612 may monitor performance of a RAN-related function, such as for a RAN-related function (e.g., such as beam prediction or other function). Either the UE 614 or the gNB 612 may detect that performance of that RAN-related function is less than a threshold. In this example, the UE 614 detects that performance of the RAN-related function is less than a threshold or not performing to a required level, and thus, ML model (e.g., biases and/or weights of a ML model or ML functionality of at least one ML model) requires adaptation or re-training based on updated data, conditions or updated signals, for example. For example, at step 3, the gNB or network may monitor performance of RAN-related function; gNB 612 may inform UE 614 to take corrective actions if performance degrades below a level, or is out of bounds. For example, gNB may determine that beam predictions from UE no longer match actual beams, so beam prediction ML model should be updated, so the gNB 612 informs UE 614 to update ML model. Performance monitoring by gNB 612 occurs when UE is using ML model in inference mode, but not when ML model is being trained/adaptation cycles. Thus, at step 4, the UE may determine that ML model requires adaptation.

At step 5 of FIG. 6, the UE determines or estimates the set of ML functionality (or ML model) adaptation parameters (MAP), such as, e.g., Nac (number of adaptation cycles in the validity period is 10 adaptation cycles), default Ncpma=1 (which may or may not be signaled), a validity period may be indicated as the period between Tend and Tstart=30 s, and Tma_avg (average duration of the adaptation cycles) is 100 ms.

At step 6, UE 614 sends the (e.g., proposed) MAP (or set of ML model adaptation parameters) via RRC message to the gNB 612. Thus, at steps 5-6: The UE 614 estimates required adaptation cycles, determines MAP and transmits MAP via signaling message to the gNB 612.

At step 7 of FIG. 6, UE 614 may also request allocation of resources for ML model adaptation, e.g., requesting specific reference signal configuration. UE requests resources for model adaptation, if UE requires certain reference signals, if it requires CSI-RS signals on a specific beam, or anything specific to ML model, then UE can make this request to gNB, so UE 614 will receive the required input signals during validity period so UE can perform ML model adaptation.

At step 8 of FIG. 6, the gNB 612 and/or UE 614 may confirm or acknowledge the (proposed) MAP. Thus, at step 8, the gNB 612 replies with ACK (acknowledgement), if the MAP configuration requested by the UE is acceptable, or with NACK, if the MAP configuration is not acceptable. The NACK is generated by the gNB in case it cannot guarantee that the configuration of the UE will remain unchanged during Tstart-Tend, for example, this can happen under high traffic load or MAP signaling (step 5) received from too many UEs, for example.

At step 9 of FIG. 6, if the UE receives ACK in step 8, when the Tstart time instance (e.g., SFN (system frame number) number or UTC time) is reached, UE starts the planned adaptation cycles (with parameters determined in step 5), performing the ML model adaptation. In case a NACK was received in Step 8, then the UE can start its model adaptation at its own risk i.e., in case it decides to start such procedure the gNB cannot guarantee the configuration will not be changed during Tstart-Tend. Thus, at step 9, UE 614 performs the ML model adaptation or retraining, or a partial adaptation or retraining, at one or more adaptation cycles during the validity period, with ML model in training mode, based on the confirmed or agreed upon MAP, depending on its own implementation specific algorithms and ML platform capabilities.

At step 10 of FIG. 6, gNB will use (or provide) the agreed configuration and/or radio resources, and/or provides the required inputs (e.g., transmits the required reference signals) from Tstart to Tend, to allow the UE to perform ML model adaptation, based on (e.g., in accordance with) the MAP. These resources, configuration and/or input signals provided by gNB 612 should remain constant during the validity period, or at least during the ML model adaptation period (and there may be multiple ML model adaptations per validity period). Also, for example, the gNB may not request UE 614 to perform RAN-related function during the validity period, and/or during at least the adaptation cycles within the validity period.

At step 11 of FIG. 6, the UE 614 may use the ML model in inference mode to perform the RAN-related function in gap(s) between successive adaptation cycles (e.g., depending on the MAP configuration).

At step 12 of FIG. 6, when the Tend time instance (e.g., system frame number (SFN) or UTC time) is reached, UE stops, ceases or deactivates the planned ML model adaptation during the adaption cycles.

At step 13 of FIG. 6, the UE may resume using the adapted or re-trained (updated) ML model in inference mode to perform the RAN-related function (similar to step 3), and then the UE and/or gNB may monitor performance of the RAN-related function to determine if another ML model adaptation or re-training is required by the UE.

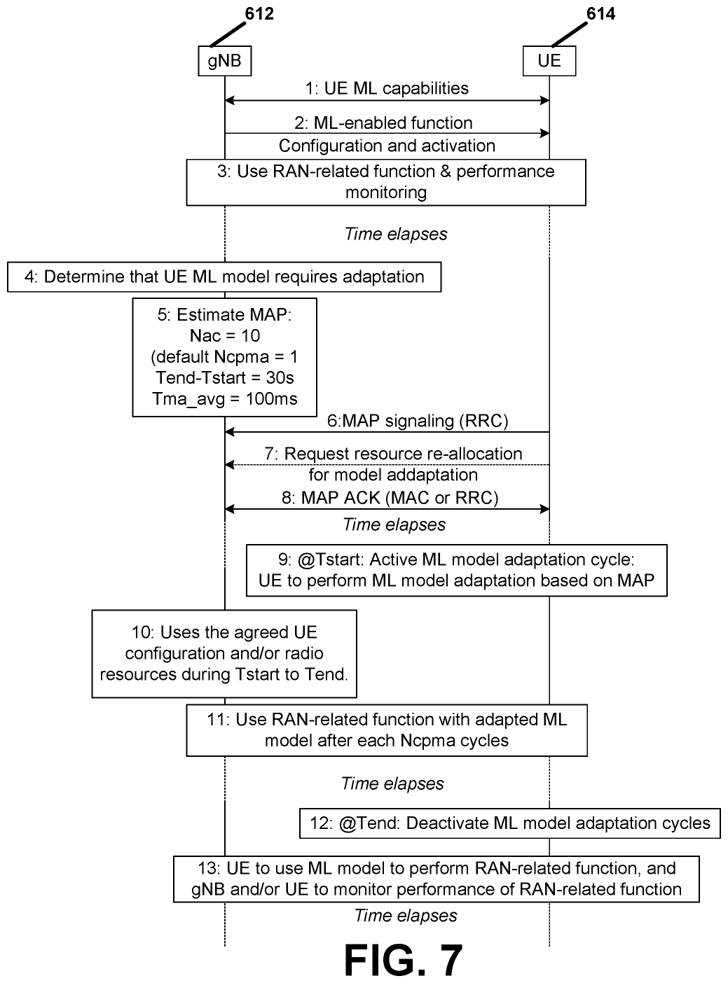

FIG. 7 is a diagram illustrating operation of a UE 614 and gNB 612 according to an example embodiment in which ML model adaptation is performed at the UE, and the set of model adaptation parameters are provided by the network node or gNB to the UE, and the gNB may detect a need for the UE to perform ML model adaptation. The operation shown in FIG. 7 is very similar to the operation shown in FIG. 6, except as the differences noted here. At step 4 of FIG. 7, the gNB 612 determines that ML model requires adaptation or re-training (e.g., gNB may detect that beam prediction performance is less than a threshold level).

At step 5 of FIG. 7, the gNB determines or estimates the set of ML functionality (or ML model) adaptation parameters (MAP), such as, e.g., Nac (number of adaptation cycles in the validity period is 10 adaptation cycles), default Ncpma=1 (which may or may not be signaled), a validity period may be indicated as the period between Tend and Tstart=30 s, and Tma_avg (average duration of the adaptation cycles) is 100 ms. At step 6 of FIG. 7, gNB 612 sends the (e.g., proposed) MAP (or set of ML model adaptation parameters) via RRC message to the UE 614. Thus, at steps 5-6 of FIG. 7: The gNB 612 estimates required adaptation cycles, determines MAP and transmits MAP via signaling message to the UE 614.

The operation at the step 4 “Determine that UE ML model requires adaptation” in FIGS. 6 and 7 may be used as a “trigger” for the activation of the ML adaptation procedure and signaling. Examples for this step 4 may be or include a mechanism such as used for data and/or model drift detection. Also, for example, the implementation of the step 4 may depend upon the ML model specifics used in the UE (including any proprietary hardware and/or software solutions) and may depends also on how the ML model has been trained and how much it can ‘generalize’ (perform with acceptable performance under various input conditions). In this example, the radio conditions also account for the number of beams and the signal strength of the FR2 radio beams which the UE can detect during its movement. Radio beams in FR2 can be easily blocked by relatively small physical obstacles, such as people, cars and trees. Thus, in the given example, we assumed that the ML model was initially trained under stationary radio channel conditions. To maintain the beam prediction performance, it is required to re-train/adapt the model when the radio conditions around the UE change due to slow movement of the UE.

The operation at the step 5 “Estimate MAP” in FIGS. 6 and 7 may depend on the type of model adaptation which is determined in step 4 and specific use case when the ML model is used. Like for step 4, this step 5, may also relies on implementation specific solutions. In the given example for UE beam prediction, based on the knowledge of the frequency band used (FR2 carrier, 25 GHz) and the approximate UE movement speed (or alternatively number of radio beam changes detected per time unit) it is expected that the radio environment around the UE would change considerably after every approx. 200 wavelengths at 25 GHz) movement. Because the long-term (time horizon) movement direction and speed of the UE are impossible to estimate for typical pedestrian scenarios, the UE algorithm in this example may set the time maximum window for the adaptation to 30 seconds, after which a re-evaluation of both step 4 and step 5 may be required.

Various additional illustrative examples and variations will now be briefly described.

Example use case (numerical values are in the realistic range but are not the only ones possible): Assume the ML-based functionality is used for UE beam management (e.g., beam prediction, a contemporary use case in 3GPP Release 18). The UE first estimates its mobility state e.g., based on the previous number of beam changes and corresponding RSRP levels recorded. As example, for a pedestrian UE moving in dense urban with 3 km/hour speed and FR2 radio environment, the mobility state estimated by the UE is ‘medium’, and therefore the UE determines that the ML model might require Nac=10 adaptations during the next 30 seconds (Tend-Tstart), corresponding to one adaptation after every 2.5 m distance (approx. 200 wavelengths at 25 GHz). Furthermore, it is a reasonable assumption that these adaptations can be run only when there is no/low user plane traffic, due to UE power consumption, therefore rather aperiodically. The UE estimates (internal algorithm, implementation specific hardware/software based) that one model adaptation cycle has in average a duration of Tma_avg=100 ms, as the total time needed for data collection, data pre-processing, re-training of some NN layers, potential test inference, and output post-processing. The re-training and potential inference steps can take much shorter time than Tma_avg, depending on the UE hardware/software platform; however, the data collection and data preparation steps are dependent on the type of radio measurements and signals used, hence the cycle duration can be easily 100 times longer compared to typical ML model inference time. With the above exemplified timing values, the UE informs the serving gNB that for Nac=10 cycles during the next Tend-Tstart=30 seconds, where each adaptation cycle has Tma_avg=100 ms length the UE is not able to transmit/receive data or, it can receive/transmit but it cannot perform any RRC reconfiguration, according to this illustrative example.

Additional embodiments: The MAP may be defined and signaled by the Network (e.g., ML orchestrator or ML training function via gNB) to the UE(s) as a form of policy which allows to realize the mapping of the detected radio conditions change(s) and the corresponding required ML model adaptations for a given RAN-related function. Optionally, when MAP is defined and provided by the network or gNB (e.g., see FIG. 7), the network can also trigger the UE ML adaptation cycles, individually or all within the Tstart to Tend time window. The trigger can happen when predefined condition is verified (e.g., performance degradation) the adaptation cycle is started and based on the performance feedback or related output observations, the optimal ML model adaptation can be selected. The aperiodic MAP cycles may be defined with specified minimum time between consecutive adaptations (Tmaintv_min) and maximum duration of an adaptation cycle (Tma_max). In combination with any other embodiments (aperiodic or periodic adaptation cycles, FIGS. 3A-3C and FIG. 4 cases), the ML model adaptation may be broken/split down into different model sections (e.g., group of neural network (NN) layers) and such sections are to be adapted/trained separately, with different rates (see FIG. 5).

In combination with any of the other embodiments (aperiodic or periodic adaptation cycles, FIGS. 3A-3C and FIG. 4 cases), the ML model adaptation cycles can be paused and resumed on request from the gNB, either during the negotiated cycles/time window, or alternatively before a new Tstart-Tend adaptation window is triggered.

Example use cases and possible implementation: For example, a deep neural network (DNN, or ML model) with L layers may have section 1: layers 1->K and section 2: layers K+1->L. Section 1 can be adapted at rate R1 (while keeping section 2 constant) and vice versa. FIG. 3 shows an example with periodic adaptation cycles and 3 model sections, to be adapted at different rates: section #1 every cycle, section #2 every 2nd cycle, and section #3 every 4th cycle.

The arrangement of the adaptation cycles in FIG. 5 can also be used to train different ML models (for the same RAN-related function) instead of the different sections of the same ML model (i.e., section #1->Model #1, Section #2->Model #2, section #3->Model #3). In this case if the model update for one of the models finished before Tend (Model #3), then the UE can also switch to using it for inference during the ‘white’ time intervals (or gaps).

### Additional Embodiments for Handling the MAP:

The MAP configuration may be (partly or completely) part of the initial UE ML Capabilities exchange.

In D2D (device to device, or UE-to-UE communication, or sidelink communications) scenarios, the UE receives the MAP from neighboring UE(s), via sidelink (SL), ProSe (proximity services), D2D and/or UE-to-UE communication protocols, to avoid the UE searching on the optimal parameters.

The gNB may configure the UE to provide event triggered or periodic reports on the status/outcome of the adaptation cycles between Tstart and Tend. The UE performing the model adaptation is configured by the serving gNB to for example: Signal the interruption (‘break of adaptation cycles’) with the initially configured MAP in case of failure (e.g., target accuracy after adaptation was not met—prior-art); this signaling can use RRC or MAC signaling channel. For example, the need for ‘break of adaptation cycles’ can be based on changing radio conditions for a UE moving from indoor to outdoor, or UE moving from low speed to high speed. Alternatively, or additionally, signal a simple status indication (Passed/Failed) after the number of configured cycles or at expiration of Tend; this signaling can use RRC or MAC signaling channels. In addition, a UE may signal an extended status Indication including context information; this signaling can use RRC or MAC signaling channels. Context information may include: The condition which triggered the ‘break of adaptation cycles’ at the UE; SFN (system frame number or other timing that indicates) when adaptation failure has been detected; an additional ML model accuracy/performance metric (if/when available); statistics of the input data used for adaptation; and/or statistics of the output after or during adaptation (if/when available).

The ‘break of adaptation cycles’ signal may include additional information, such as the cause of the break (see above) and/or what ML model is used after the signal has been sent (other/old ML model or non-ML, fallback based functionality). Alternatively, or additionally, the ‘break of adaptation cycles’ signal is sent by the serving gNB to the UE executing the model adaptation. For example, the need for ‘break of adaptation cycles’ can be based on required NW configuration changes, which are not compatible with the current configuration used by the UE to update the model(s) and which cannot be delayed until Tend.

### Example Use Cases:

Security attack detection: An ML model is running at the UE in order to detect/predict the occurrence of security attack (such as rogue base stations). In fact, the UE uses its measurement reports (conventionally made for other procedures such as handover) in order to detect security attacks before harmful consequences are observed. However, mainly due to environmental changes, the ML model needs updates within a limited time window (time horizon) to ensure optimal performance in terms of detection accuracy. The UE determines that ML model adaptation requires Nac=10 aperiodic adaptation cycles (e.g., when resources are available), with an average cycle duration Tma_avg=100 ms, during the next 30 seconds (Tend-Tstart).

Beam prediction: When ML model is employed at UE in order to predict the next best beam and trigger beam switching/handover towards this beam without explicitly measuring it. For example, the UE first estimates its mobility state e.g., based on the previous number of beam/cell changes and corresponding RSRP levels recorded. For a pedestrian UE moving in dense urban, FR2 radio environment the mobility state could be estimated by the UE as ‘medium’, and therefore the UE determines that the ML model requires Nac=10 periodic adaptations cycles, each with cycle duration Tma=100 ms, during the next 30 seconds (Tend-Tstart).

CSI prediction/compression: When ML model is employed at UE in order to predict the CSI for given time horizon without explicitly measuring it. For example, the UE first estimate its mobility state e.g., based on the previous number of beam/cell changes. If there is significant change detected e.g., from low to high mobility, the ML model used for CSI prediction requires adaptation, and therefore the UE determines that the ML model requires Nac=10 periodic adaptations cycles, each with cycle duration Tma=10 ms, during the next 1 seconds (Tend-Tstart) to re-tune the model for the new channel conditions.

Positioning: When ML model is employed at the UE, or gNB, in order to predict the LOS/NLOS state of the UE channel conditions. For example, the UE ML algorithm estimates (predicts) the LOS/NLOS state based on CSI measurements and channel impulse response (CIR) estimation. Due to detected changing radio conditions, based on S(I)NR and fast fading conditions (mobility), the UE determines that the ML model requires Nac=10 aperiodic adaptations, each with cycle duration Tma=200 ms, during the next 10 seconds (Tend-Tstart).

The numerical values given for the examples and illustrative use cases described herein, are provided purely for example or illustration purposes, and other numerical values may be used.

Some examples will now be described.

Example 1. A method comprising: confirming, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and performing, by the user device, adaptation of the ML functionality during the at least one adaptation cycle.

Example 2. The method of Example 1, wherein the at least one adaptation cycle comprises a plurality of adaptation cycles, wherein the performing adaptation comprises performing, by the user device, adaptation of the ML functionality during the plurality of adaptation cycles; the method further comprising: using, by the user device, the at least one ML model in inference mode to perform or assist in performing the RAN-related function between the adaptation cycles.

Example 3. The method of any of Examples 1-2, wherein the confirming comprises: transmitting, by the user device to the network node, the set of ML functionality adaptation parameters for performing adaptation of the ML functionality; and receiving, by the user device from the network node, an acknowledgement confirming that the set of ML functionality adaptation parameters are acceptable.

Example 4. The method of any of Examples 1-2, wherein the confirming comprises: receiving, by the user device from the network node, the set of ML functionality adaptation parameters for performing adaptation of the ML functionality; and transmitting, by the user device to the network node, an acknowledgement confirming that the set of ML functionality adaptation parameters are acceptable.

Example 5. The method of any of Examples 1-4, wherein the set of ML functionality adaptation parameters comprises information indicating: the validity period for which the ML functionality adaptation parameters are valid; a number of adaptation cycles within the validity period; and an adaptation cycle duration for each adaptation cycle of the at least one adaptation cycle.

Example 6. The method of Example 5, wherein the at least one adaptation cycle comprises a plurality of adaptation cycles, wherein the adaptation cycle duration for the plurality of adaptation cycles comprises at least one of: an adaptation cycle duration for the plurality of adaptation cycles within the validity period, wherein the adaptation cycle duration is the same for each of the adaptation cycles; or an average adaptation cycle duration for the adaptation cycles within the validity period.

Example 7. The method of any of Examples 1-4, wherein the at least one adaptation cycle comprises a plurality of adaptation cycles, wherein the set of ML functionality adaptation parameters comprises at least one of the following: a number of ML functionality adaptations; a number of the adaptation cycles per ML functionality adaptation; a duration, or an average duration, of the adaptation cycles; a time period between each of the adaptation cycles; or an average time period between each of the adaptation cycles.

Example 8. The method of any of Examples 1-7, wherein one or more inputs to the ML functionality, which are configured by the network node, remain constant during the validity period.

Example 9. The method of any of Examples 1-7: wherein performing adaptation of the ML functionality comprises: performing a plurality of ML functionality adaptations, wherein each ML functionality adaptation comprises a plurality of adaptation cycles; wherein one or more inputs to the ML functionality, which are configured by the network node, remain constant within each of the ML functionality adaptations; and wherein the one or more inputs to the ML functionality, which are configured by the network node, are changed between two of the ML functionality adaptations during the validity period.

Example 10. The method of any of Examples 1-9, further comprising: transmitting, by the user device to the network node, a capabilities response indicating that the user device has a capability to perform at least one of the following: ML functionality or ML model adaptation; receiving, by the user device, the set of ML functionality adaptation parameters; or sending or providing, by the user device to the network node, the set of ML functionality adaptation parameters or a proposed or requested set of ML functionality adaptation parameters.

Example 11. The method of any of Examples 1-10, wherein the performing, by the user device, adaptation of the ML functionality during at least one of the plurality of adaptation cycles is performed based on at least one of the following: receiving, by the user device from the network node, a request to perform adaptation of the ML functionality; or detecting, by the user device, a need to perform adaptation of the ML functionality based on performance of the RAN-related function being less than a threshold.

Example 12. The method of any of Examples 1-11, further comprising: transmitting, by the user device to the network node, a request for resources to be used by the user device during the plurality of adaptation cycles within the validity period to perform adaptation of the ML functionality.

Example 13. The method of any of Examples 1-12, wherein adaptation of the ML functionality is performed partially in an iterative manner during each adaptation cycle of the plurality of adaptation cycles.

Example 14. The method of any of Examples 1-13, wherein the performing, by the user device, adaptation of the ML functionality comprises performing at least one of the following: adapting one or more weights or biases of the at least one ML model; adapting the at least one ML model; adapting a plurality of ML models; or adapting an architecture and/or model structure of at least one ML model.

Example 15. An apparatus comprising: at least one processor; and at least one memory including computer program code; the at least one memory and the computer program code configured to, with the at least one processor, cause the apparatus at least to perform the method of any of Examples 1-14.

Example 16. A non-transitory computer-readable storage medium comprising instructions stored thereon that, when executed by at least one processor, are configured to cause a computing system to perform the method of any of Examples 1-14.

Example 17. An apparatus comprising means for performing the method of any of Examples 1-14.

Example 18. An apparatus comprising: at least one processor; and at least one memory including computer program code; the at least one memory and the computer program code configured to, with the at least one processor, cause the apparatus at least to: confirm, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and performing, by the user device, adaptation of the ML functionality during the at least one adaptation cycle.

Example 19. The apparatus of Example 18, wherein the at least one adaptation cycle comprises a plurality of adaptation cycles, wherein the performing adaptation comprises performing, by the user device, adaptation of the ML functionality during the plurality of adaptation cycles; the at least one processor and the computer program code configured to further cause the apparatus to: use, by the user device, the at least one ML model in inference mode to perform or assist in performing the RAN-related function between the adaptation cycles.

Example 20. The apparatus of any of Examples 18-19, wherein the at least one processor and the computer program code configured to cause the apparatus to confirm comprises the at least one processor and the computer program code configured to cause the apparatus to: transmit, by the user device to the network node, the set of ML functionality adaptation parameters for performing adaptation of the ML functionality; and receive, by the user device from the network node, an acknowledgement confirming that the set of ML functionality adaptation parameters are acceptable.

Example 21. The apparatus of any of Examples 18-19, wherein the at least one processor and the computer program code configured to cause the apparatus to confirm comprises the at least one processor and the computer program code configured to cause the apparatus to: receive, by the user device from the network node, the set of ML functionality adaptation parameters for performing adaptation of the ML functionality; and transmit, by the user device to the network node, an acknowledgement confirming that the set of ML functionality adaptation parameters are acceptable.

Example 22. The apparatus of any of Examples 18-21, wherein the set of ML functionality adaptation parameters comprises information indicating: the validity period for which the ML functionality adaptation parameters are valid; a number of adaptation cycles within the validity period; and an adaptation cycle duration for each adaptation cycle.

Example 23. The apparatus of Example 22, wherein the at least one adaptation cycle comprises a plurality of adaptation cycles, wherein the adaptation cycle duration for the plurality of adaptation cycles comprises at least one of: an adaptation cycle duration for the plurality of adaptation cycles within the validity period, wherein the adaptation cycle duration is the same for each of the adaptation cycles; or an average adaptation cycle duration for the adaptation cycles within the validity period.

Example 24. The apparatus of any of Examples 18-21, wherein the at least one adaptation cycle comprises a plurality of adaptation cycles, wherein the set of ML functionality adaptation parameters comprises at least one of the following: a number of ML functionality adaptations; a number of the adaptation cycles per ML functionality adaptation; a duration, or an average duration, of the adaptation cycles; a time period between each of the adaptation cycles; or an average time period between each of the adaptation cycles.

Example 25. The apparatus of any of Examples 18-24, wherein one or more inputs to the ML functionality, which are configured by the network node, remain constant during the validity period.

Example 26. The apparatus of any of Examples 18-24, wherein the at least one processor and the computer program code configured to cause the apparatus to confirm perform adaptation of the ML functionality comprises the at least one processor and the computer program code configured to cause the apparatus to: perform a plurality of ML functionality adaptations, wherein each ML functionality adaptation comprises a plurality of adaptation cycles; wherein one or more inputs to the ML functionality, which are configured by the network node, remain constant within each of the ML functionality adaptations; and wherein the one or more inputs to the ML functionality, which are configured by the network node, are changed between two of the ML functionality adaptations during the validity period.

Example 27. The apparatus of any of Examples 18-26, wherein the at least one processor and the computer program code are configured to further cause the apparatus to: transmit, by the user device to the network node, a capabilities response indicating that the user device has a capability to perform at least one of the following: receive, by the user device, the set of ML functionality adaptation parameters; or send or provide, by the user device to the network node, the set of ML functionality adaptation parameters or a proposed or requested set of ML functionality adaptation parameters.

Example 28. The apparatus of any of Examples 18-27, wherein the at least one processor and the computer program code configured to cause the apparatus to perform, by the user device, adaptation of the ML functionality during at least one of the plurality of adaptation cycles is performed based on the at least one processor and the computer program code configured to cause the apparatus to perform at least one of the following: receive, by the user device from the network node, a request to perform adaptation of the ML functionality; or detect, by the user device, a need to perform adaptation of the ML functionality based on performance of the RAN-related function being less than a threshold.

Example 29. The apparatus of any of Examples 18-28, wherein the at least one processor and the computer program code are configured to further cause the apparatus to: transmit, by the user device to the network node, a request for resources to be used by the user device during the plurality of adaptation cycles within the validity period to perform adaptation of the ML functionality.

Example 30. The apparatus of any of Examples 18-29, wherein adaptation of the ML functionality is performed partially in an iterative manner during each adaptation cycle of the plurality of adaptation cycles.

Example 31. The apparatus of any of Examples 18-30, wherein the at least one processor and the computer program code configured to cause the apparatus to perform, by the user device, adaptation of the ML functionality comprises the at least one processor and the computer program code configured to cause the apparatus to: adapt one or more weights or biases of the at least one ML model; adapt the at least one ML model; adapt a plurality of ML models; or adapt an architecture and/or model structure of at least one ML model.

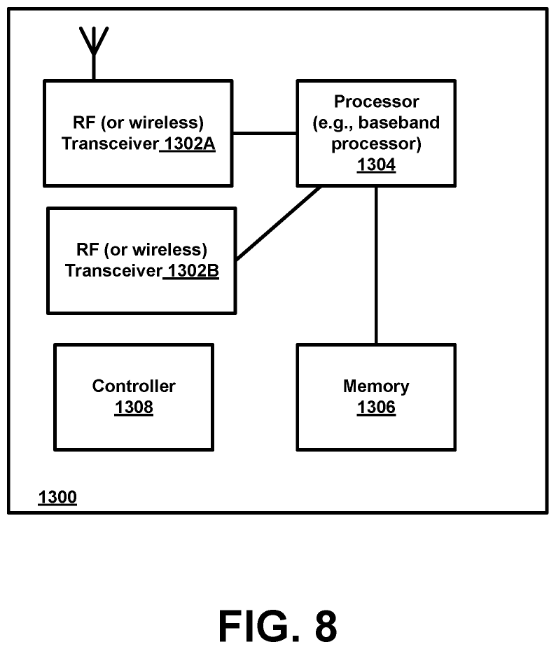

FIG. 8 is a block diagram of a wireless station or node (e.g., UE, user device, AP, BS, eNB, gNB, RAN node, network node, TRP, or other node) 1300 according to an example embodiment. The wireless station 1300 may include, for example, one or more (e.g., two as shown in FIG. 8) RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 8, a controller (or processor) 1308 may execute software and instructions, and may provide overall control for the station 1300, and may provide control for other systems not shown in FIG. 8, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example embodiment, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
confirming, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and
performing, by the user device, adaptation of the ML functionality during the at least one adaptation cycle.

2. The method of claim 1, wherein the at least one adaptation cycle comprises a plurality of adaptation cycles, wherein the performing adaptation comprises performing, by the user device, adaptation of the ML functionality during the plurality of adaptation cycles;
the method further comprising:
using, by the user device, the at least one ML model in inference mode to perform or assist in performing the RAN-related function between the adaptation cycles.

3. The method of claim 1, wherein the confirming comprises:
transmitting, by the user device to the network node, the set of ML functionality adaptation parameters for performing adaptation of the ML functionality; and
receiving, by the user device from the network node, an acknowledgement confirming that the set of ML functionality adaptation parameters are acceptable.

4. The method of claim 1, wherein the confirming comprises:
receiving, by the user device from the network node, the set of ML functionality adaptation parameters for performing adaptation of the ML functionality; and
transmitting, by the user device to the network node, an acknowledgement confirming that the set of ML functionality adaptation parameters are acceptable.

5. The method of claim 1, wherein the set of ML functionality adaptation parameters comprises information indicating:
the validity period for which the ML functionality adaptation parameters are valid;
a number of adaptation cycles within the validity period; and
an adaptation cycle duration for each adaptation cycle of the at least one adaptation cycle.

6. The method of claim 5, wherein the at least one adaptation cycle comprises a plurality of adaptation cycles, wherein the adaptation cycle duration for the plurality of adaptation cycles comprises at least one of:
an adaptation cycle duration for the plurality of adaptation cycles within the validity period, wherein the adaptation cycle duration is the same for each of the adaptation cycles; or
an average adaptation cycle duration for the adaptation cycles within the validity period.

7. The method of claim 1, wherein the at least one adaptation cycle comprises a plurality of adaptation cycles, wherein the set of ML functionality adaptation parameters comprises at least one of the following:
a number of ML functionality adaptations;
a number of the adaptation cycles per ML functionality adaptation;
a duration, or an average duration, of the adaptation cycles;
a time period between each of the adaptation cycles; or
an average time period between each of the adaptation cycles.

8. The method of claim 1, wherein one or more inputs to the ML functionality, which are configured by the network node, remain constant during the validity period.

9. The method of claim 1:
wherein performing adaptation of the ML functionality comprises:
performing a plurality of ML functionality adaptations, wherein each ML functionality adaptation comprises a plurality of adaptation cycles;
wherein one or more inputs to the ML functionality, which are configured by the network node, remain constant within each of the ML functionality adaptations; and
wherein the one or more inputs to the ML functionality, which are configured by the network node, are changed between two of the ML functionality adaptations during the validity period.

10. The method of any of claim 1, further comprising:
transmitting, by the user device to the network node, a capabilities response indicating that the user device has a capability to perform at least one of the following:
ML functionality or ML model adaptation;
receiving, by the user device, the set of ML functionality adaptation parameters; or
sending or providing, by the user device to the network node, the set of ML functionality adaptation parameters or a proposed or requested set of ML functionality adaptation parameters.

11. The method of claim 1, wherein the performing, by the user device, adaptation of the ML functionality during at least one of the plurality of adaptation cycles is performed based on at least one of the following:
receiving, by the user device from the network node, a request to perform adaptation of the ML functionality; or
detecting, by the user device, a need to perform adaptation of the ML functionality based on performance of the RAN-related function being less than a threshold.

12. The method of claim 1, further comprising:
transmitting, by the user device to the network node, a request for resources to be used by the user device during the plurality of adaptation cycles within the validity period to perform adaptation of the ML functionality.

13. The method of claim 1, wherein adaptation of the ML functionality is performed partially in an iterative manner during each adaptation cycle of the plurality of adaptation cycles.

14. The method of claim 1, wherein the performing, by the user device, adaptation of the ML functionality comprises performing at least one of the following:
adapting one or more weights or biases of the at least one ML model;
adapting the at least one ML model;
adapting a plurality of ML models; or
adapting an architecture and/or model structure of at least one ML model.

15. An apparatus comprising:
at least one processor; and
at least one memory including computer program code;
the at least one memory and the computer program code configured to, with the at least one processor, cause the apparatus at least to:
confirm, by a user device with a network node, a set of machine learning (ML) functionality adaptation parameters for the user device to perform adaptation of a ML functionality associated with at least one ML model that is used by the user device to perform a radio access network (RAN)-related function, the set of ML functionality adaptation parameters indicating at least one adaptation cycle during which the user device is to perform the ML functionality adaptation and a validity period for which the set of ML functionality adaptation parameters are valid; and
perform, by the user device, adaptation of the ML functionality during the at least one adaptation cycle.

16. The apparatus of claim 15, wherein the at least one adaptation cycle comprises a plurality of adaptation cycles, wherein the performing adaptation comprises performing, by the user device, adaptation of the ML functionality during the plurality of adaptation cycles;
the at least one processor and the computer program code configured to further cause the apparatus to:
use, by the user device, the at least one ML model in inference mode to perform or assist in performing the RAN-related function between the adaptation cycles.

17. The apparatus of claim 15, wherein the at least one processor and the computer program code configured to cause the apparatus to confirm comprises the at least one processor and the computer program code configured to cause the apparatus to:
transmit, by the user device to the network node, the set of ML functionality adaptation parameters for performing adaptation of the ML functionality; and
receive, by the user device from the network node, an acknowledgement confirming that the set of ML functionality adaptation parameters are acceptable.

18. The apparatus of claim 15, wherein the at least one processor and the computer program code configured to cause the apparatus to confirm comprises the at least one processor and the computer program code configured to cause the apparatus to:
receive, by the user device from the network node, the set of ML functionality adaptation parameters for performing adaptation of the ML functionality; and
transmit, by the user device to the network node, an acknowledgement confirming that the set of ML functionality adaptation parameters are acceptable.

19. The apparatus of claim 15, wherein the set of ML functionality adaptation parameters comprises information indicating:
the validity period for which the ML functionality adaptation parameters are valid;
a number of adaptation cycles within the validity period; and
an adaptation cycle duration for each adaptation cycle.

20. The apparatus of claim 19, wherein the at least one adaptation cycle comprises a plurality of adaptation cycles, wherein the adaptation cycle duration for the plurality of adaptation cycles comprises at least one of:
an adaptation cycle duration for the plurality of adaptation cycles within the validity period, wherein the adaptation cycle duration is the same for each of the adaptation cycles; or
an average adaptation cycle duration for the adaptation cycles within the validity period.
